(19) United States
(12) Patent Application Publication
(10) Pub. No.: US 2007/0088648 A1
(43) Pub. Date: Apr. 19, 2007

(54) System and Method for Determining Data Points for Financial Bar Charts and Their Presentation

(75) Inventors: Timothy S. Mather, Englewood, CO (US); Michael J. Glista, Homer Glen, IL (US); Ernst Popke, Highlands Ranch, CO (US)

Correspondence Address: FAEGRE & BENSON LLP;PATENT DOCKETING, 2200 WELLS FARGO CENTER, 90 SOUTH SEVENTH STREET, MINNEAPOLIS, MN, 55402-3901, US

(73) Assignee: CQG,Inc., Denver, CO (US)

(21) Appl. No.: 11/531,397

(22) Filed: Sep. 13, 2006

Related U.S. Application Data
(60) Provisional application No. 60/727,748, filed on Oct. 17, 2005.
(60) Provisional application No. 60/772,671, filed on Feb. 13, 2006.
(60) Provisional application No. 60/781,211, filed on Mar. 10, 2006.
(60) Provisional application No. 60/833,095, filed on Jul. 25, 2006.

(51) Int. Cl. G06Q 40/00

(52) U.S. Cl. 705/36 R

(57) ABSTRACT

A method for analyzing financial data related to a financial instrument traded on an electronic exchange includes serially receiving sets of price and volume data including a price corresponding to a best bid, a best ask, or a trade, and a volume representing the volume of units of the financial instrument available at the best bid price or best ask price or executed at the trade price, and generating a data point including a best bid price, a best ask price, a high price, a low price, a bid trade volume, a bid large trade volume, an ask trade volume, and an ask large trade volume of the financial instrument in the discrete time period, and determining whether the inside market has moved based at least in part on a relationship between the most recently received price and one or more of the current best bid price, the current best ask price, the current high price, and the current low price.

### RELATED APPLICATIONS

This application claims the benefit of Provisional Application Nos. 60/727,748, filed on Oct. 17, 2005; 60/772,671, filed on Feb. 13, 2006; 60/781,211 filed on Mar. 10, 2006; and 60/833,095, filed on Jul. 25, 2006, all of which are hereby incorporated by reference for all purposes.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright© 2006 CQG Inc.

### BACKGROUND

In the field of financial trading, trading of financial instruments (e.g., securities, commodity, currency, or index futures, options, etc.) is typically done today through an electronic exchange, rather than on the historical “trade floor”. Trading through an electronic exchange enables virtually anyone with a computer to trade directly with the exchange. Via a trader's computer that accesses the exchange via a network, the trader can obtain real-time or historical financial data, place trade orders (e.g., bids and asks), perform a wide range of financial analyses, and much more. In addition, data can be presented to the trader in various useful formats, such as graphical or alphanumeric. The type of data presented, the manner and timeliness of presentation, and the data manipulations performed by the trader's financial application are important factors that can more or less improve the trader's ability to make informed decisions and profit in the market.

For example, financial data may be presented in the form of a bar chart. Conventionally, a price bar chart includes a vertical line (a bar) representing the range of prices spanned for a security in one day of trading. The top of the vertical line indicates the highest price a security traded at during the day, and the bottom represents the lowest price. The closing price is displayed on the right side of the bar, and the opening price is shown on the left side of the bar. While conventional methods for generating and presenting bar charts can be useful, they are generally fairly limited in their indication of current and likely future trends of financial data. Of course, traders would prefer to be able to predict future prices with a high degree of confidence in order to increase their chances of profitability. As such, other methods for presenting bar charts, and computing their corresponding data, are desired.

### SUMMARY

Some embodiments relate to a computer-implemented method for analyzing financial data related to a financial instrument traded on an electronic exchange, in which the method includes serially receiving sets of price and volume data that each include a price corresponding to a best bid, a best ask, or a trade, and a volume representing the volume of units of the financial instrument available at the best bid price or best ask price or executed at the trade price. The method further includes generating a data point corresponding to the current discrete time period of trading, in which the data point includes a start time of the discrete time period, a best bid price, a best ask price, a high price, a tow price, a bid trade volume, a bid large trade volume, an ask trade volume, and an ask large trade volume of the financial instrument in the discrete time period. The method further includes determining whether the inside market has moved based at least in part on a relationship between the most recently received price and one or more of the current best bid price, the current best ask price, the current high price, and the current low price in the discrete time period. If the inside market has not moved, the price and volume values of the current data point are updated using the most recently received price and volume set. If the inside market has moved, the current data point is stored, a new data point is initialized, and the new data point is updated using the most recently received price and volume set. The foregoing steps are typically repeated during another discrete time period.

The method may further include, for each set of received price and volume data that corresponds to a best bid or a best ask, setting the best bid price for the current discrete time period equal to the received bid price or setting the current best ask price for the current discrete time period to the received ask price and then determining if the current best ask price is less than or equal to the current best bid price, and if the current best bid price is less than or equal to the current high price, indicating that the inside market has not moved.

Determining whether the inside market has moved may further include if the current best ask price is greater or equal to the current best bid price, determining whether the current best bid price is greater than or equal to the current high price in the discrete time period, and if the current best bid price is greater than or equal to the current high price, indicating that the inside market has moved. Determining whether the inside market has moved may further include determining whether the current best bid price is greater than the current low price in the discrete time period if the current best bid price is less than the current high price, and indicating that the inside market has not moved if the current best bid price is less than or equal to the current low price. Determining whether the inside market has moved may still further include, if the current best bid price is greater than the current low price, determining whether a current best bid price in the discrete time period has been traded; and if the current low price in the discrete time period has been traded, indicating that the inside market has moved. Determining whether the inside market has moved may yet further include, if the current best bid price has not been traded, determining whether the current best ask price is less than or equal to a current low price in the discrete time period; and if the current best ask price is less than or equal to the current low price, indicating that the inside market has moved. Further still, determining whether the inside market has moved may include if the current best ask price is greater than the current low price, determining whether a current best ask price is greater than or equal to the current high price, and if the current best ask price is greater than or equal to the current high price, indicating that the inside market has not moved. Yet further still, determining whether the inside market has moved may further include if the current best ask price is less than the current high price determining whether a current high price in the discrete time period has been traded; and if the current high price in the discrete time period has been traded, indicating that the inside market has moved. Determining whether the inside market has moved may further include indicating that the inside market has not moved if the current high price in the discrete time period has not been traded.

Determining whether the inside market has may involve, for each set of received set of price and volume data that corresponds to an executed trade, determining whether the price of the trade is greater than a current high price during the discrete time period or less than a current low price in the discrete time period, and, if the price of the trade is greater than the current high price or less than the current low price, then indicating that the inside market has moved.

The method may further involve attributing half the volume of a trade to the bid trade volume and half the volume of the trade to the ask trade volume if the current best bid price in the discrete time period is greater than or equal to the current best ask price in the discrete time period. The method of may further include attributing all of the volume of a trade to the bid trade volume if the current best ask price in the discrete time period is greater than or equal to the current best bid price in the discrete time period and if the price of the received trade is less than or equal to a current best bid price in the discrete time period. The method may include attributing all of the volume of a trade to the ask trade volume if the current best ask price in the discrete time period is greater than or equal to the current best bid price in the discrete time period and if the price of the trade is greater than or equal to a current best ask price during the discrete time period.

The method may further include proportionately attributing volume of a trade to the bid trade volume and the ask trade volume based on the linearly interpolated difference of trade price relative to the current best bid price and the current best ask price if the current best ask price in the discrete time period is greater than or equal to the current best bid price in the discrete time period and if the price of the trade is greater than a current best bid price of the discrete time period and less than a current best ask price of the discrete time period. The method may further include attributing a portion of the bid trade volume to large trades executed during the discrete time period and a portion of the ask trade volume to large trades executed during the discrete time period, wherein a large trade is a single trade of a financial instrument with a trade volume greater than a large volume threshold or a sequence of trades of a financial instrument, uninterrupted by the receipt of a new best bid or new best ask or by a change in the inside market, with a cumulative trade volume greater than a large volume threshold. The large volume threshold may be user-selectable.

The method may still further include displaying a price bar chart wherein each bar represents the data point for a discrete time period with a high price set to either the highest best ask price of the discrete time period that was traded or, if no trades occurred at the ask price, the lowest ask price that occurred over the duration of the discrete time period, a low price set to either the lowest best bid price of the discrete time period that was traded or, if no trades occurred at the bid price, the highest best bid price that occurred over the duration of the discrete time period, a bid trade volume set to the proportion of the total trade volume allocated to the best bid price during the discrete time period and an ask trade volume set to the proportion of the total trade volume allocated to the best ask price during the discrete time period. The method may further include determining a total trade volume for a pre-determined number of prior discrete time periods, computing a percent rank based on a comparison of the total volume in the current discrete time period to the distribution of the total trade volume in the pre-determined number of prior discrete time periods, selecting a bar width, a bid color shade, and an ask color shade based on the percent rank, displaying the bar with the selected width, with the bid portion in the bid color shade, and with the ask portion in the ask color shade. The method may still further include setting a plurality of percentage thresholds, wherein at each threshold a different color shade is associated with ask trade percentages above the threshold, and a different color shade is associated with bid trade percentages above the threshold. Setting the thresholds may include setting four percentage thresholds corresponding to an extra large volume level, a large volume level, a medium volume level, and a small volume level. The method may still further include displaying the bid and/or the ask portion in a color shade associated with the extra large volume level when the bid or the ask percent rank is above the percentage threshold associated with the extra large volume level, displaying the bid and/or the ask portion in a color shade associated with the large volume level when the bid or the ask percent rank is above the percentage threshold associated with the large volume level and below the percentage threshold associated with the extra large volume level, displaying the bid and/or the ask portion in a color shade associated with the medium volume level when the bid or the ask percent rank is above the percentage threshold associated with the medium volume level and below the percentage threshold associated with the large volume level, and displaying the bid and/or the ask portion in a color shade associated with the small volume level when the bid or the ask percent rank is above the percentage threshold associated with the small volume level and below the percentage threshold associated with the medium volume level. If both the bid trade volume and the ask trade volume correspond to zero volume, a particular color shade may be associated with zero volume.

The method may still further include displaying a volume histogram chart wherein each histogram bar represents the data point for a discrete time period of trading with a bid trade volume set to the proportion of the total trade volume allocated to the best bid price during the discrete time period and an ask trade volume set to the proportion of the total trade volume allocated to the best ask price during the discrete time period. The graphical representation may include a bid trade volume portion displayed with a first aspect and an ask trade volume portion displayed with a second aspect. Displaying may include displaying the bid trade volume portion in a first color and displaying the ask trade volume portion in a second color. The first color and the second color may be user-selectable.

The method may still further include displaying a volume histogram chart wherein each histogram bar represents the data point for a discrete time period of trading with a bid trade volume set to the proportion of the total trade volume allocated to the best bid price during the discrete time period, a bid large trade volume set to the proportion of the bid trade volume attributed to large trades, an ask trade volume set to the proportion of the total trade volume allocated to the best ask price, and an ask large trade volume set to the proportion of the ask trade volume attributed to large trades during the discrete time period. The graphical representation may include a bid trade volume portion displayed with a first aspect, a bid large trade volume portion displayed with a second aspect, an ask trade volume portion displayed with a third aspect, and an ask large trade volume portion displayed with a fourth aspect. Displaying may include displaying the bid trade volume portion in a first color, the bid large trade volume portion in a second color, displaying the ask trade volume portion in a third color, and displaying the ask large trade volume portion in a fourth color. The four colors may be individually user-selectable.

The generating and displaying steps may be performed using real-time financial data from the electronic exchange or historical financial data from the electronic exchange.

A computer program product can include computer executable instructions that cause a computer to carry out a process including sequentially calculating a plurality of data points wherein each data point is calculated over a time period of trading, and wherein each data point includes a high price, a low price, a best bid price, a best ask price, a bid trade volume, a bid large trade volume, an ask trade volume and an ask large trade volume for the discrete time period, and wherein calculating each data point includes updating the high price, the low prices the best bid price, the best ask price, the bid trade volume, the bid large trade volume, the ask trade volume and the ask large trade volume based on a plurality of market data points received during the discrete time period, wherein each market data point includes a price and a volume and a type indicator indicating whether the price and volume correspond to an ask order, a bid order, or an executed trade. The process may further includes during each discrete time period, determining whether to begin calculating another data point over a next discrete time period by comparing the price of a most recently received market data point to one or more of the best bid price, the best ask price, the current high price, and the current low price most recently updated during the discrete time period.

Calculating a data point may further include allocating volume of each market data point to one or both of bids and asks placed during the associated discrete time period, and wherein allocating may further include dynamically updating a bid trade volume and an ask trade volume during the associated discrete time period.

The process may still further include, during each discrete time period, displaying a bar representing the data point being calculated, wherein the bar includes a bid trade volume portion corresponding to the determined bid trade volume, and an ask trade volume portion corresponding to the determined ask trade volume, and dynamically updating the bid portion and the ask portion of the bar as the bid trade volume and the ask trade volume are dynamically updated. Allocating volume of each market data point may include comparing the price of the market data point to one or more of the best bid price and the best ask price most recently updated during the discrete time period. Allocating volume of each market data point may include linearly interpolating the price of the market data point between the most recent best bid price and the most recent best ask price during the discrete time period.

### BRIEF DESCRIPTION OF THE DRAWINGS

FIG. 1 illustrates an exemplary operating environment in which embodiments of the present invention may operate.

FIG. 2 illustrates an exemplary bar chart in accordance with various embodiments.

FIGS. 3-4 illustrate user interfaces enabling user to set up parameters for use in presenting bar charts.

FIGS. 5-9 are flow charts illustrating exemplary algorithms for determining data points and presenting bar charts.

FIG. 10 illustrates an exemplary computing device upon which embodiments of the present invention can operate.

### DETAILED DESCRIPTION

Embodiments of methods and systems are described for generating financial charts. More specifically, systems and methods are disclosed for determining data points used in generating bars in bar charts. Algorithms are presented that determine when and how the data points are generated. Data points for a bar are determined in a manner that provides information about changes in the inside market price and/or in trade volume. In this manner, a trader may be able to more readily identify possible trends in price, volume, or other financial data. In addition, the timing of generating new data points and their corresponding bars is based on various events of interest in the market. In some algorithms, the events of interest are used as indicators of changes in market trends.

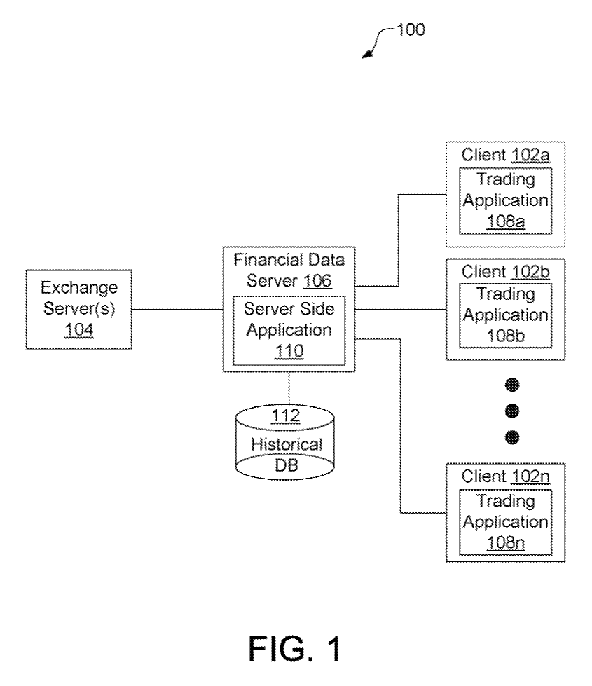

FIG. 1 illustrates an exemplary operating environment 100 in which embodiments of the present invention may be employed. One or more traders use client computers or terminals 102a-n to analyze data and place trade orders at electronic exchange server(s) 104. The electronic exchange server(s) 104 are servers associated with the electronic exchange that accept trade orders, provide requested data, provide a substantially real-time stream of bids ask, and trade prices and volumes, and other data manipulation related to the electronic exchange. The clients 102a-n communicate with a financial data server 106 that facilitates communication of financial data and placement of trade orders.

Trading applications 108a-n operate on clients 102a-n, respectively. Trading applications 108a-n each gather financial data, process the data, present selected data to the trader on a display (not shown) receive input from the trader, and transmit trade orders to the server 106. More specifically, the trading applications 108a-n communicate with a server side application 110. The server side application 110 is operable to obtain selected data from the exchange server(s) 104 and communicate data to the exchange server(s) 104. Data communicated to the exchange server(s) 104 may be, for example, elements of trade orders, such as buy or sell, quantity, stop or limit prices, or others.

In the embodiment shown, financial data server 106 utilizes a database 112 for storing data, such as historical price and volume data. Server application 110 and client applications 108a-n can use and present real-time data and historical data from historical database 112. The database 112 may store data in any form suitable for the particular implementation, such as, but not limited to, a relational database and flat files. As such, the database 112 may or may not be accessed via a structured query language (SQL), for example. In addition, financial data server 106 can include cache memory (not shown) for caching selected data, which may be used again later. The server 106 may at times remove selected data from the cache, based on caching rules.

In some embodiments, clients 102a-n can subscribe to selected financial instruments, and financial information, or services. Clients 102a-n, financial data server 110, and exchange server(s) 104 communicate via one or more networks. The networks may be wireless, wired, or a combination of wired and wireless. Network components (not shown) and/or components at the clients 102a-n, financial data server 110, and exchange server 104, such as firewalls and network address translators (NATs), may provide for data and system security.

Data communicated between the clients 102a-n and the financial data server 106, and between the financial data server 106 and the exchange server(s) 104 may be “pushed” or “pulled”, or any combination thereof, depending on the situation. For example, akin to pulling, the client 102a may request historical data from the financial data server 106, which will prompt the server side application 110 to retrieve the requested data from the database 112 and send the data to the client 102a. On the other hand, real-time data from the exchange server(s) 104 is typically pushed to one or more of the clients 102a-n by the server side application 110.

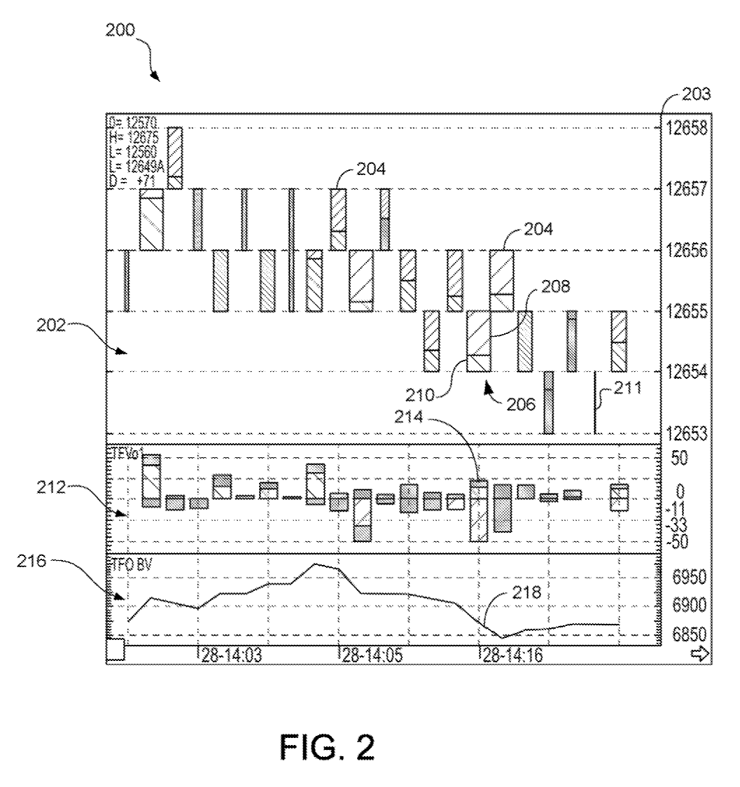

FIG. 2 illustrates an exemplary display 200 of data related to a financial instrument in accordance with one embodiment. The display 200 includes a bid/ask range bar chart 202 providing bid/ask range price and trade volume information. In the embodiment illustrated, the bid/ask range bar chart 202 reflects the directional movement of the best bid/ask range or inside market over time. As such, embodiments can better illustrate short-term historical price and trade volume fluctuations for a financial instrument being monitored.

Each bar 204 in the bar chart 202 corresponds to, or is based upon, a bid/ask range data point. In accordance with various embodiments, a bid/ask range data point includes one or more data values such as, but not limited to, a start time, an open price, a high price, a low price, a close price, a bid trade volume, a bid trade volume due to large trades, an ask trade volume, and an ask trade volume due to large trades. Each data point corresponds to a finite time duration during a trading session or trading sessions. Time is shown along the bottom horizontal axis of the chart 200, proceeding from right (most recent) to left (least recent). When a new bar is displayed, the bars in the chart shift to the left, the leftmost (oldest) bar is no long displayed, and the new bar is displayed to the right of the bars, at a vertical position where the prices of the new bar correspond to the prices along the right vertical price axis 203.

With more specific reference to the bid/ask range bars 204, various attributes of the bid/ask range data points can be presented in different ways to convey information to the viewer. By way of example, different colors and/or color intensities and/or the bar widths can be used to indicate bid trade volume and ask trade volume information to the viewer. According to one embodiment, bid trade volume relative to ask trade volume may be communicated to a trader by visually depicting individual bars 204 of the bar chart 202 in two or more different colors and/or multiple intensities and/or multiple bar widths. For example, the proportion of the total volume traded at the bid for a particular bid/ask range bar 206 may be conveyed by coloring a first portion 208 of the bar 206 a first color (e.g., green, depicted with crosshatching in a first orientation). Within the first portion 208, the amount of trading volume attributed to the bid is depicted with shades of the first color (e.g., shades of green) having increasing visual intensity (e.g., brighter shading) associated with corresponding increases in the total volume of the bar. Similarly, the proportion of the total volume traded at the ask for a particular bid/ask range bar 206 may be conveyed by coloring a second portion 210 of the bar 206 a second color (e.g., red, depicted with crosshatching in a second orientation). Within the second portion 210, the amount of trading volume attributed to the ask is depicted with shades of the second color (e.g., shades of red) having increasing visual intensity (e.g., brighter shading) associated with corresponding increases in the total volume of the data point. Similarly, increases in the total volume of a data point may be conveyed to the viewer by increasing the width of the bar.

According to an alternative embodiment, a bid/ask range bar 204 may be assigned a single uniform color depending on whether it is determined to reflect buying or selling pressure. For example, if the inside market has moved up and the volume traded at the ask price is greater than the volume traded at the bid price, the bar might be colored an intense green reflecting high buying pressure. If the inside market has moved down and the volume traded at the ask price is greater than the volume traded at the bid price, the bar might be colored a less intense green reflecting low buying pressure. Similarly, if the inside market has moved down and the volume traded at the bid price is greater than the volume traded at the ask price, then the bar might be colored an intense red reflecting high selling pressure. If the inside market has moved up and the volume traded at the bid is greater than the volume traded at the ask price, then the bar might be colored a less intense red reflecting low selling pressure.

If no trading occurred for a period of time between two bars, the bid/ask range bar 204 corresponding to that time period might be assigned a neutral color such as grey. This is illustrated in the bid/ask range bar chart 202 in bar 211.

FIG. 2 also illustrates an exemplary bid/ask range volume histogram chart 212. Each histogram bar 214 corresponds to, or is based upon, a bid/ask range data point. Displaying a new histogram bar is done in a similar fashion to a new bid/ask range bar. When a new histogram bar is to be displayed, the leftmost (oldest) histogram bar is no long displayed, the other bars are shifted to the left, and the new histogram bar is displayed to the right of the bars.

FIG. 2 also illustrates an exemplary bid/ask range on-balance volume line chart 216. The line 218 on the chart corresponds to, or is based upon, an aggregation of the volumes of successive bid/ask range data points. When a new portion of the on-balance line is to be displayed, the line is shifted to the left, with the leftmost (oldest) portion no longer being displayed, and the new portion being added contiguously to the right most end of the on-balance line.

Although the bar chart 202, the histogram 212, and the volume line chart 216 are illustrated together in the display 200, it will be understood by those skilled in the art that these charts can be presented separately or in any combination. For example, in some embodiments, the bar chart 202 is displayed with the volume histogram chart 212, but without the on-balance volume line chart 216. As another example, the on-balance volume line chart 216 may be displayed with the bar chart 202, but without the volume histogram chart 212. In addition, in accordance with various embodiments, the particular combination of charts that is displayed is user configurable.

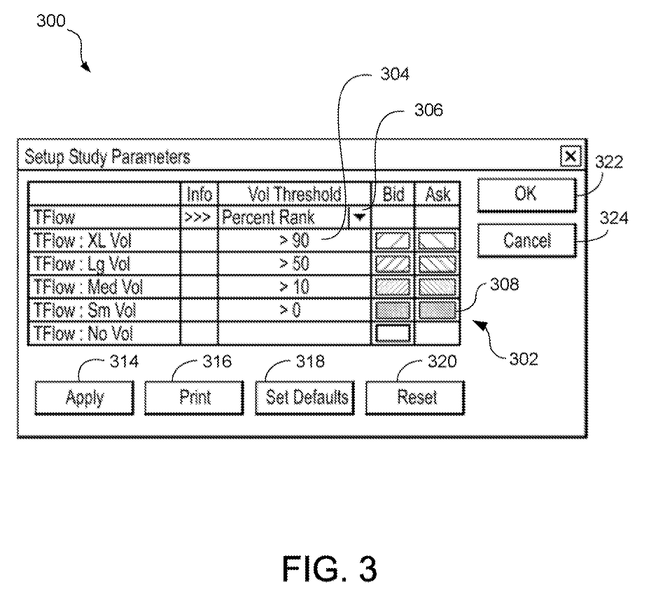

FIG. 3 illustrates an exemplary user interface 300 for configuring certain aspects of a bid/ask range bar chart, such as the bid/ask range bar chart 202. In this embodiment, the user interface 300 is based on the popular Windows™ operating system from Microsoft™ Corporation, however the user interface 300, and other user interfaces described herein, are not limited to the Windows™ operating system. For example, embodiments described herein could be readily adapted to the Linux™ operating systems, or other operating systems. Included in the user interface 300 are a number of user selectable and/or configurable elements, with which the user can set parameters used in presenting bar charts.

According to the illustrated embodiment, a user interactive volume-based color range table 302 enables the user to set colors and color intensities associated with different volume thresholds, for use in displaying bars in the bar chart. The user can select a volume threshold type using the volume threshold mode selector, such as drop down menu 306, and set volume thresholds using threshold specification elements 304 to distinguish between different volume thresholds. In the particular example shown, the threshold values are specified as a percentage rank of the total volume for the current data point relative to the total volume of a pre-determined number of prior (historical) data points. In this particular embodiment, there are five volume levels: extra large (XL Vol), large (Lg Vol), medium (Med Vol), small (Sm Vol), and zero volume (No Vol). To illustrate just one possible configuration, in FIG. 3, the extra large volume threshold is set at 90%, the threshold for the large volume threshold is set at 50%, the threshold for the medium volume threshold is set at 10%, and the threshold for the small volume threshold is set at 0%. Of course, these volume thresholds are purely exemplary and could be changed to any other values that the user desires.

For each volume threshold, the user can specify a color and a shade for the portion of the bid/ask range bar representing the bid volume and for the portion of the bid/ask range bar representing the ask volume, as well as zero volume threshold, using color specification elements 308. Thus, according to the exemplary settings shown in FIG. 3, a bar will be displayed with a bright green portion representing the bid volume and a bright red portion representing the ask volume when the total trade volume is ranked above the upper 90th percentile of the historical total trade volume, a regular green portion representing the bid volume and a regular red portion representing the ask volume when the total trade volume is ranked between the 50th percentile and 90th percentile of the historical total trade volume; a dark green portion representing the bid volume and a dark red portion representing the ask volume when the total trade volume is ranked between the 10th percentile and 50th percentile of the historical total trade volume; and a very dark green portion representing the bid volume and a very dark red portion representing the ask volume when the total trade volume is ranked between 0 and the 10th percentile of the historical total trade volume. A bar for which no bid or ask trade volume (i.e., zero volume) occurred will be colored grey.

According to an alternative embodiment, an end user, such as a trader, may be able to choose to set the volume thresholds that are used to determine the intensity of the color and/or the width of the bid/ask range bars to be volume thresholds expressed as actual volume values or as percentages of a base volume where the base volume may be expressed as an absolute value or be algorithmically determined, for example, by calculating a median or a moving average of the historical volume values. A volume threshold mode drop down menu 306 can be used to set the mode of specifying the volume thresholds. In this embodiment, the volume threshold specification modes are absolute volume, percentage of historical volume, and percentage of a base volume.

To set a color, shade, or intensity for a bid or ask portion of the bid/ask range bar, the user selects (e.g., clicks on with a pointer device) the corresponding color specification element 308. In response, a color selector (not shown) is presented that offers multiple colors and/or shades of colors, from which the user may select.

Other user selectable graphical elements on the user interface 300 include an apply button 314, a print button 316, a set defaults button 318, a reset button 320, an ok button 322, and a cancel button 324. When selected, the apply button 314 causes the user set colors and shades to be applied to the bar chart currently displayed. The set defaults button 318 can be used to set or reset the specified colors, shades, and/or threshold values in the table 302 to default values. Selection of the reset button 320 resets the specified colors, shades, and/or threshold values in the table 302 to values that existed prior to the user changing those values. The functions of the generic user interface elements described here for user interface 300 are replicated in user interface 400.

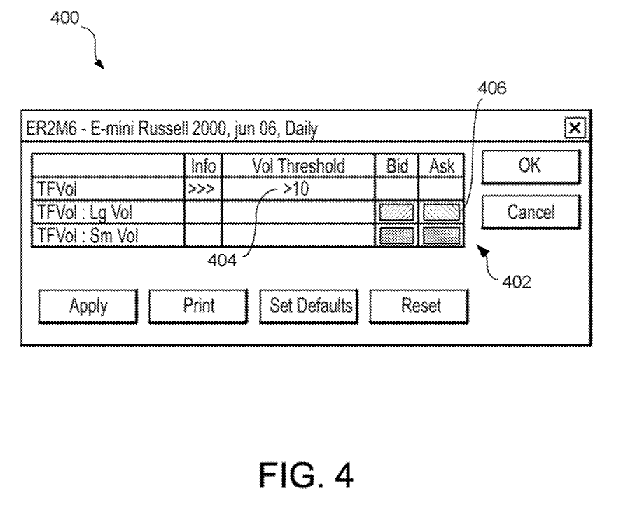

FIG. 4 illustrates an exemplary user interface 400 for configuring aspects of a bid/ask range volume histogram chart, such as volume histogram chart 212 described above. The interface 400 includes a color specification table 402. As in the user interface 300 described above the user of the user interface 400 can set volume thresholds using threshold specification elements 404, to distinguish between different volume thresholds in bars in the histogram chart. At each volume thresholds the user can select the corresponding color, shade or intensity using color specification elements 406. When the user selects a color specification element 406, a color selector (not shown) is presented that includes multiple colors or shades from which the user can choose.

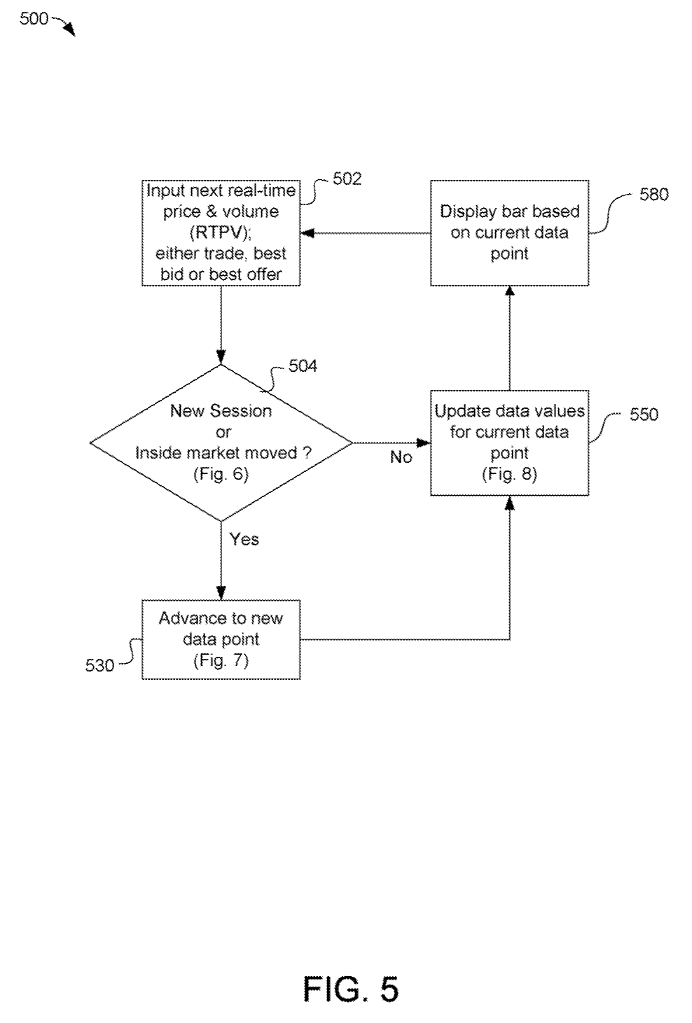

FIG. 5 is a flowchart illustrating an algorithm 500 for generating bid/ask range data points for a selected financial instrument in accordance with one embodiment of the present invention. In general, the data point generation algorithm 500 repeats over time, generating a new data point during each discrete time period as determined by the data point advancing algorithm 530 discussed below.

An inputting operation 502 receives the next or first realtime price and volume (RTPV) of the selected financial instrument for the associated time period. The RTPV may be obtained from an executed trade, a best bid pending in the market, or a best offer that is pending in the market. While the algorithm 500 is expressed in terms of real-time price and volume other embodiments may apply to generation of data points utilizing input from a historical database of the price and volume information.

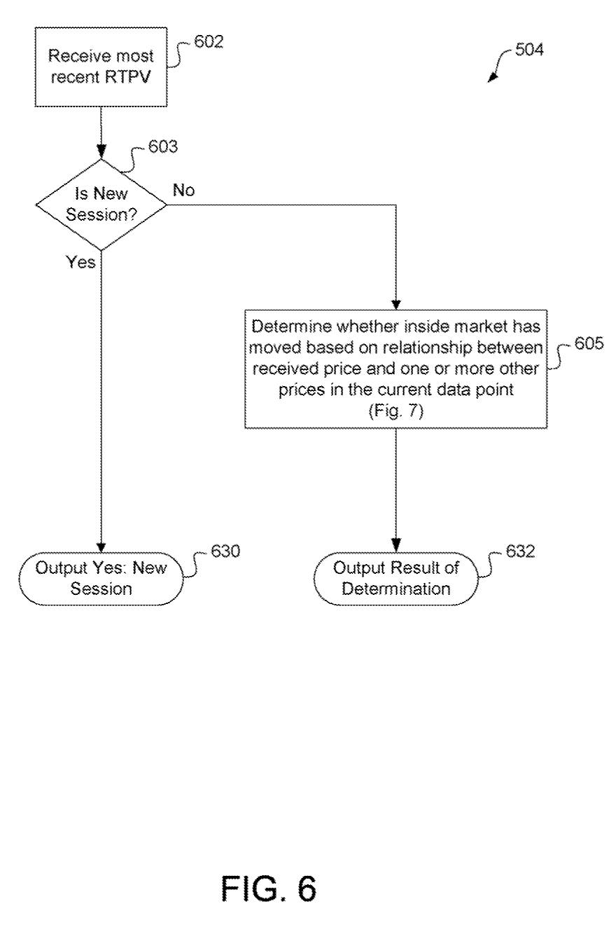

A query operation 504 determines if it is time to advance to a new bar in the bar chart. In accordance with various embodiments, the query operation 504 checks whether one of a set of specified bar advancing events has occurred. An exemplary algorithm illustrating one embodiment of the query operation 504 is shown in FIG. 6 and is discussed below. By way of example, but not limitation the query operation 504 can check whether the inside market has moved or a new session has started. Typically, the start of a new session is defined by the exchange trading hours or by user defined custom session hours.

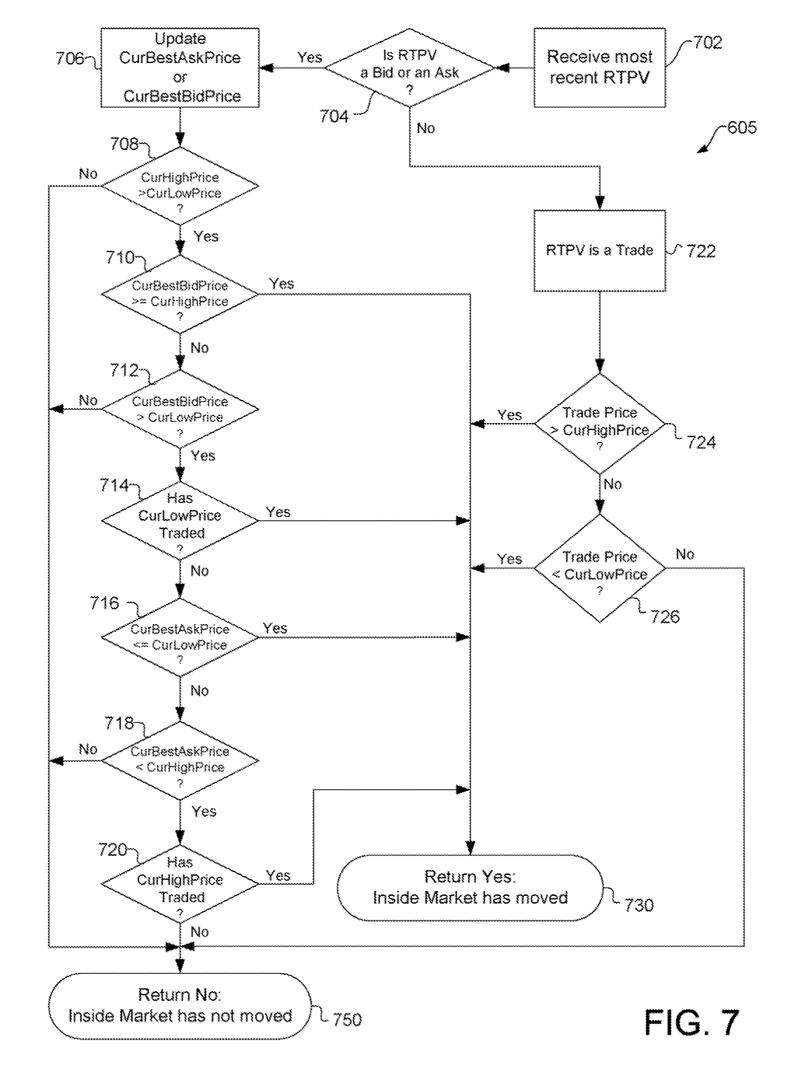

If the inside market has moved (or another bar advancing event has occurred), the data point generation algorithm 500 branches “Yes” to an advancing operation 530 which prepares to generate a new data point. In one embodiment, the advancing operation 530 initializes the data values associated with the new bid/ask range data point. An exemplary algorithm illustrating one embodiment of the advancing operation 530 is shown in FIG. 7 and discussed below.

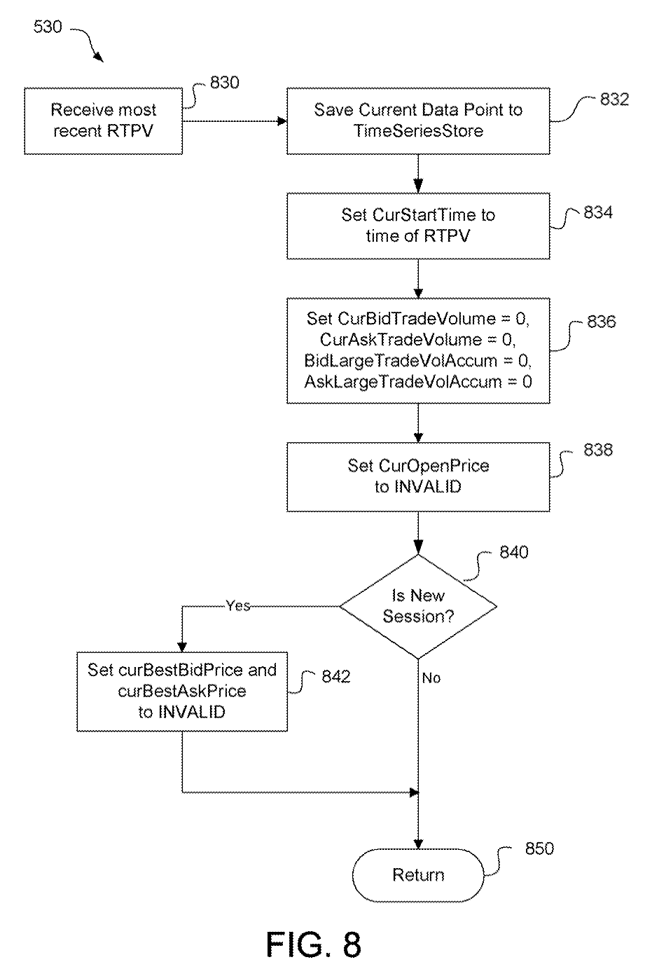

If the inside market has not moved (and no other bar advancing event has occurred), the data point generation algorithm 500 branches “No” to a data value updating operation 550. An exemplary algorithm illustrating one embodiment of the data value updating operation 550 is shown in FIG. 8 and discussed below.

In the data value updating operation 550, the RTPV received in the receiving operation 502 is used to update price and volume data values associated with the data point currently being determined; i.e., in the current time period.

After the updating operation 550, the algorithm branches to a displaying operation 580. Displaying operation 580 displays a bar on the computer display screen, using the values stored in the current data point. In addition, the displaying operation 580 presents the bar using various display aspects, such as colors, color shades, color intensities, and bar widths, depending on the data values and configured settings (e.g., those set by the user using user interfaces 300 (FIG. 3) and 400 (FIG. 4), FIG. 2, discussed above, illustrates how bars could be displayed in accordance with one embodiment. If a histogram bar chart and/or an on-balance line chart are being displayed, they will also be advanced using values in the current data point.

Although not shown, other operations could take place using the current data point. For example, the current data point could be used for various studies or analyses, as well as automatic trading. These other operations, if any, could take place serially, or in parallel with, operations of algorithm 500.

From the displaying operation 580, the algorithm returns to the inputting operation 502, where the next RTPV is determined.

In exemplary embodiments data points are generated at various times during a trading session or trading sessions. Each data point corresponds to a finite time duration. In various embodiments, the start time and end time of each finite time duration are determined according to an algorithm 504, discussed further below. Between the start time and end time, the elements of the current data point are calculated, as illustrated in FIG. 5 and discussed herein, based on financial data received from an electronic exchange.

FIG. 6 is a flowchart illustrating one embodiment of algorithm 504 for determining whether an advancing event has occurred. In this particular embodiment, it is determined whether the inside market has moved or a new session has started and thus to advance to a new bid/ask range data point for a selected financial instrument.

An inputting operation 602 receives the next or first realtime price and volume (RTPV) of the selected financial instrument. The RTPV may be obtained from an executed trade, a best bid pending in the market, or a best offer that is pending in the market. While the algorithm 504 is expressed in terms of realtime prices and volumes, other embodiments may apply to generation of data points utilizing input from a historical database of the price and volume information.

A query operation 603 determines if the received RTPV is the first RTPV in a new session. If a new session has started, the algorithm 504 branches to returning operation 630, which outputs an indication that a new session has started. If a new session has not started, the algorithm 504 branches to a determining operation 605. The determining operation 605 determines whether the inside market has moved based at least in part, upon a relationship or relationships between the received price and one or more other prices in the current data point, such as the current low price, the current high price, the current best ask price, and/or the current best bid price. An exemplary embodiment of the determining operation 605 is illustrated in FIG. 7. After the determining operation 605, the result of the determining operation 605 is returned in a returning operation 632.

In the embodiment shown in FIG. 7, initially a query operation 704 receives an RTPV from the inputting operation 702 and determines if the received RTPV corresponds to a bid or an ask. If the received RTPV corresponds to a bid or an ask, the algorithm 605 branches to the update operation 706 to set the current data point's best bid price to the received bid price or the best ask price to the received ask price and then to the query operation 708 to determine if the current high price is greater than the current low price. If the result of the query operation 708 is “No”, the algorithm branches to the output operation 750.

If the result of query operation 708 is “Yes”, the algorithm branches to the query operation 710 to determine if the current best bid price is greater than or equal to the current data point's high price. If the result of query operation 710 is “Yes”, the algorithm branches to the output operation 730. If the result of query operation 710 is “No”, the algorithm branches to the query operation 712 to determine if the current best bid price is greater than the current low price. If the result of query operation 712 is “No”, the algorithm branches to the output operation 750.

If the result of query operation 712 is “Yes” the algorithm branches to the query operation 714 to determine if any trade volume has been accrued for the current low price. In one embodiment, this involves determining whether the current low price has been traded. If the result of query operation 714 is “Yes”, the algorithm branches to the output operation 730.

If the result of query operation 714 is “No”, the algorithm 605 branches to the query operation 716 to determine if the ask price is less than or equal to the current data point's low price. If the result of query operation 716 is “Yes”, the algorithm branches to the output operation 730. If the result of query operation 716 is “No” the algorithm branches to the query operation 718 to determine if the ask price is less than the current high price. If the result of query operation 718 is “No”, the algorithm branches to the output operation 750.

If the result of query operation 718 is “Yes”, the algorithm 605 branches to the query operation 720 to determine if any trade volume has been accrued for the current high price. In one embodiment, this involves determining whether the current high price has been traded. If the result of query operation 720 is “Yes”, the algorithm branches to the output operation 730. If the result of query operation 720 is “No” the algorithm branches to the output operation 750 for the current data point.

Referring again to the query operation 704, if the query operation 704 determines that the received RTPV does not correspond to a bid or an ask, the algorithm 605 branches to the operation 722 because the RTPV is necessarily a trade, and then to the query operation 724 to determine if the trade price is greater than the high price of the current data point. If the result of the query operation 724 is “Yes”, the algorithm branches to the output operation 730.

If the result of the query operation 724 is “No”, the algorithm branches to the query operation 726 to determine if the trade price is less than the low price of the current data point. If the result of the query operation 726 is “Yes”, the algorithm branches to the output operation 730. In output operation 730, an indication is returned that the inside market has moved. If the result of query operation 726 is “No”, the algorithm branches to the output operation 750 for the current data point. In the output operation 750, an indication is returned that the inside market has not moved.

In the embodiment of the algorithm 605 shown in FIG. 7 the output operation 730 returns “Yes” to indicate that the algorithm 500 (FIG. 5) should advance to a new data point. In the algorithm 605, the output operation 750 returns “No” to indicate that the algorithm 500 should branch to the current data point value update operation.

A new bid/ask range data point may be generated if the inside market changes even though there has not been any trading activity.

In an alternative embodiment, a new aggregated data point may be generated according to an alternative algorithm defined by the aggregation over a collection of the bid/ask range data points resulting from changes in the inside market. The extent of the collection of bid/ask range data points may be user-defined.

A bid/ask range data point includes one or more data values such as, but not limited to a start time, an open price, a high price, a low price, a close price, a mid price, a bid trade volume due to all trades that were executed at the bid price, a bid trade volume due to large trades that were executed at the bid price, an ask trade volume due to all trades that were executed at the ask price, and an ask trade volume due to large trades that were executed at the ask price.

FIG. 8 is a flowchart illustrating one possible embodiment of algorithm 530 for advancing to a new data point. An inputting operation 830 receives the next or first realtime price and volume (RTPV) of the selected financial instrument. A data save operation 832 is performed to save the current data point to a time series data store. Then the algorithm branches to an initialization operation 834 which sets the start time for the current data point equal to the time of the RTPV. An initialization operation 836 sets the bid trade volume, the bid large trade volume accumulator, the ask trade volume, and the ask large trade volume accumulator for the current data point to 0 and another initialization operation 838 sets the open price of the current data point to INVALID.

The algorithm 530 then branches to the query operation 840 to determine if a new session has started. If the result of the query operation 840 is “No” the algorithm branches directly to the return operation 850. If the result of the query operation 840 is “Yes” then the algorithm branches to the initialization operation 842 which sets the best bid price and the best ask price for the current data point to INVALID before proceeding to the return operation 850.

In accordance with various embodiments, the open price represents the price of the first trade that was received for the current data point. If no trades occurred before the current data point is terminated then the open price is set to an invalid value.

According to at least one embodiment, the high price is set to either the highest best ask price of the current data point that was traded or, if no trades occurred at the ask price, the lowest best ask price that occurred over the duration of the current data point.

In exemplary embodiments the low price is set to either the lowest best bid price of the current data point that was traded or, if no trades occurred at the bid price, the highest best bid price that occurred over the duration of the current data point.

In accordance with some embodiments, the close price is set to the price of the last trade that was received for the current data point. The close price for the current data point is initialized to the close price of the prior data point. At the beginning of a session the close price is initialized to an invalid value. The close price remains invalid until a trade occurs.

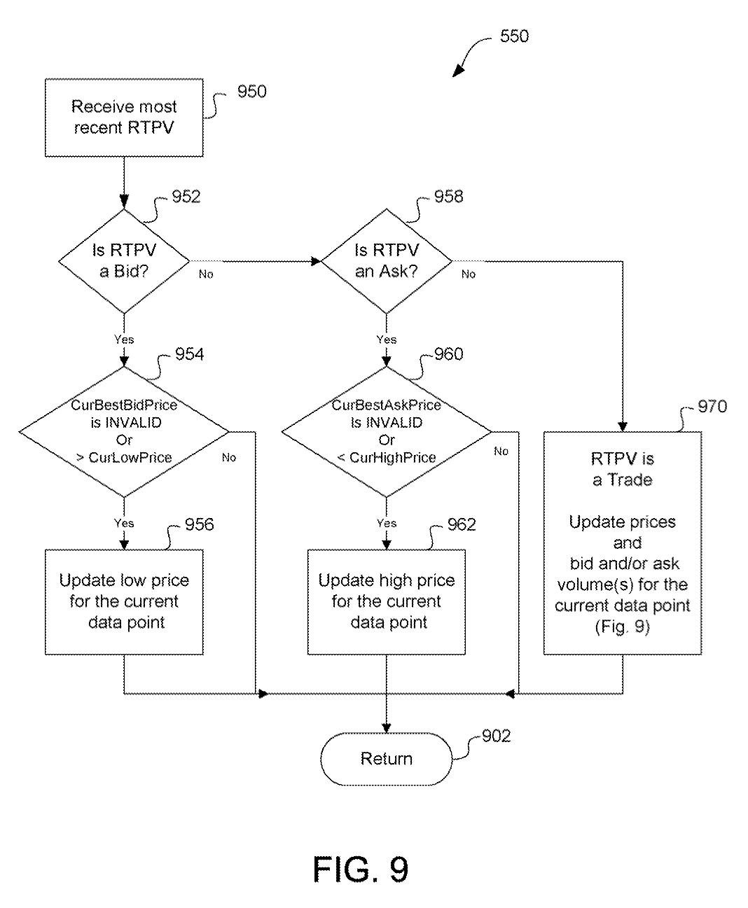

FIG. 9 is a flowchart illustrating an embodiment of algorithm 550 for updating the current data point values. An inputting operation 950 receives the next or first realtime price and volume (RTPV) of the selected financial instrument and branches to the query operation 952 to determine if the RTPV is a bid. If the result of the query operation 952 is “Yes”, the algorithm branches to a query operation 954 to determine if the current best bid price is INVALID or if the real time price (RTP) is greater that the low price of the current data point. If the result of the query operation 954 is “No”, the algorithm 550 branches directly to the return operation 902, which returns to the calling process. If the result of the query operation 954 is “Yes” the algorithm 550 branches to the updating operation 956 which sets the low price of the current data point equal to the RTP.

If the result of the query operation 952 in “No”, the algorithm 550 branches to a query operation 958 to determine if the RTPV is an ask. If the result of the query operation 958 is “Yes”, the algorithm branches to the query operation 960 to determine if the current best ask price is INVALID or if the RTP is greater that the high price of the current data point. If the result of the query operation 960 is “No”, the algorithm branches directly to the return operation 902. If the result of the query operation 960 is “Yes”, the algorithm branches to the updating operation 962 which sets the high price of the current data point equal to the RTP.

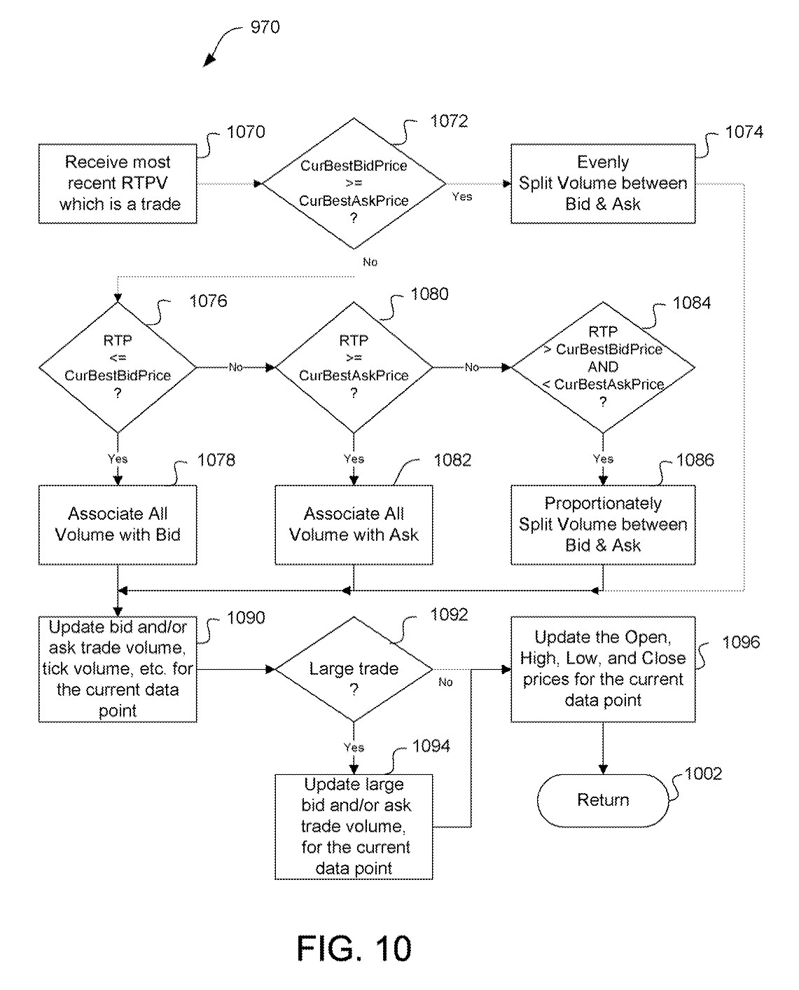

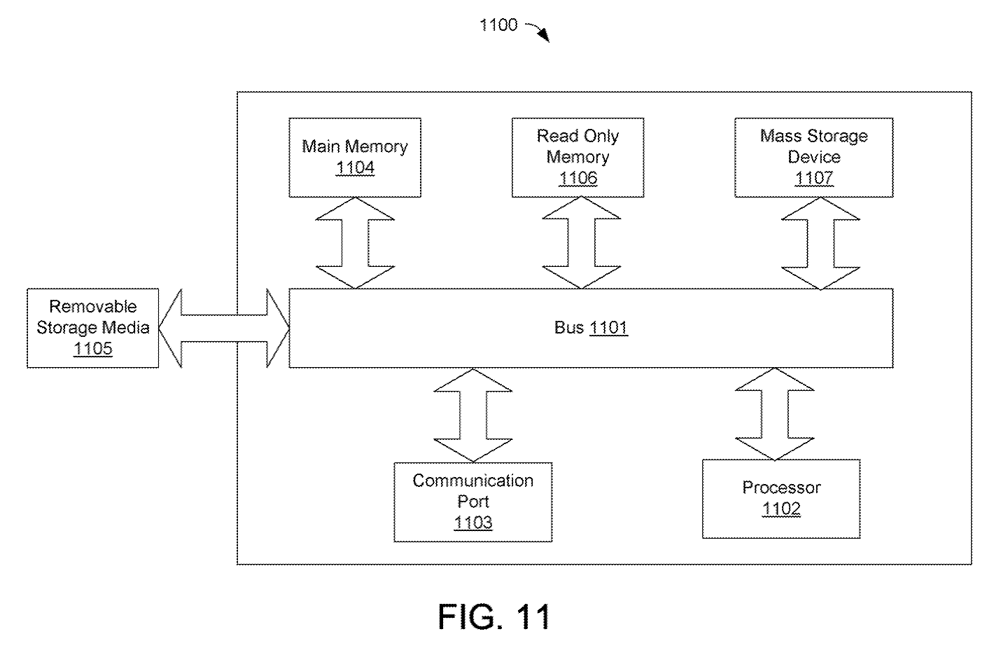

If the result of the query operation 958 in “No”, the RTPV is a trade and the algorithm 550 branches to an updating operation 970 which sets price and volume values for the current data point and then to the return operation 902. An exemplary embodiment of the updating operation 970 is illustrated in FIG. 10 and discussed below.

Information regarding the distribution of traded volume at a particular price or within a particular price range may be categorized and displayed in bar chart form as “bid trade volume”, that is, volume traded at the bid price, or “ask trade volume”, that is, volume traded at the ask price to illustrate the relative volume of trading activity occurring as favoring either buying or selling. In an exemplary embodiment, trade volume is allocated either as bid trade volume or as ask trade volume according to the algorithm 970 as described in the flowchart in FIG. 10 and discussed below.

If the price of a trade is less than or equal to the price of the current best bid, all of the traders volume is associated with the bid.

If the price of a trade is greater than or equal to the price of the current best ask, all of the trade's volume is associated with the ask.

If the price of a trade is less than the price of the current best ask and greater than the price of the current best bid, the trade's volume is split among the bid and ask. In one embodiment, the amount of the trade volume attributed to the bid and the ask of the trade is proportional to the distance from the trade price to the best bid price and the best ask price (the closer the trade price is to the best bid price, the more volume of the trade is associated with the bid).

According to various embodiments, the bid trade volume is set to the volume of the trades on the bid side, accumulated over the duration of the current data point. Ask trade volume is set to the volume of the trades on the ask side, accumulated over the duration of the current data point.

A market may become “crossed” during the pre-open period or, for some instrument types, even during an active market. Therefore, embodiments of the data point generating algorithm properly accommodate the “crossed” state. If the best bid and best ask prices are equal or crossed and a trade occurs, half of the trade's volume is associated with the bid and half of its volume is associated with the ask.

In an alternative embodiment, the bid trade volume and the ask trade volume may be further categorized as having resulted from large trades.

FIG. 10 is a flowchart illustrating an embodiment of algorithm 970 for updating the price and volume values for current data point. As discussed above, the updating operation 970 occurs when the received real-time price and volume (RTPV) correspond to an executed trade. In general, the algorithm 970 shown in FIG. 10 accommodates multiple situations in which a trade could have been executed, with reference to the current best bid order (or simply “the bid”) and the current best ask order (or simply “the ask”). Depending on the situation, the volume of the trade, or a portion of the volume of the trade, may be attributed to the bid and/or the ask.

Attributing volume (or a portion thereof) to a bid or an ask generally refers to associating the volume (or a portion thereof) with the best bid or the best ask. In other words, FIG. 10 may be understood as determining what portion of a trade's volume is to be allocated to the bid or the ask. In some cases, all of the trade volume is attributed to the bid, with none of the volume being attributed to the ask. In other cases, all of the trade volume is attributed to the ask, with none of the volume being attributed to the bid. In still other cases, a portion of the volume is attributed to the bid, and a portion of the volume is attributed to the ask. In the embodiment shown in FIG. 11, the determination as to how to “split” or apportion the trade volume to the bid and/or the ask is made based on the relative values of the best bid price, the best ask price, and the trade price.

Prior to discussing the details of the algorithm 970, it should be noted that while determining whether a traded volume should be attributed to a large trade, the algorithm 970 accommodates a large order split into multiple parts because only smaller counterparty orders exist in the counterparty order queue or depth of market. For example, if an order to buy calls for 100 shares, and the first order in the ask queue is smaller than 100 shares, the buy order may be matched with a sell order in the ask queue for 20 shares another sell order in the ask queue for 30 shares, and a final sell order in ask queue for 50 shares. During this trade sequence, multiple trade RTPVs may be received in the algorithm 970 without any updates to the best ask volume and the volume is associated with the ask and is accumulated to determine the total volume of the trade. A large trade sequence is terminated when an RTPV other than of type trade is received or when it has been determined that the inside market has moved.

Referring now more specifically to FIG. 10, an inputting operation 1070 receives the next or first real-time price and volume (RTPV) of the selected financial instrument which is a trade and branches to the query operation 1072 to determine if the best bid price is greater than or equal to the best ask price of the current data point. If the result of the query operation 1072 is “Yes”, the algorithm 970 branches to the assignment operation 1074 which allocates the trade volume equally between the bid and the ask and then to the updating operation 1090.

If the result of the query operation 1072 is “No”, the algorithm 970 branches to the query operation 1076 to determine if the real time price (RTP) is less than or equal to the best bid price of the current data point. If the result of query operation 1076 is “Yes”, the algorithm branches to the assignment operation 1078 which allocates all of the trade volume to the bid before proceeding to the updating operation 1090.

If the result of the query operation 1076 is “No”, the algorithm 970 branches to the query operation 1080 to determine if the RTP is greater than or equal to the best ask price of the current data point. If the result of query operation 1080 is “Yes”, the algorithm branches to the assignment operation 1082 which allocates all of the trade volume to the ask before proceeding to the updating operation 1090.

If the result of the query operation 1080 is “No”, the algorithm 970 branches to the query operation 1084 to determine if the RTP is greater than the best bid price and less than the best ask price of the current data point. If the result of query operation 1084 is “Yes”, the algorithm branches to the assignment operation 1086 which proportionately allocates the trade volume to the bid and the ask based on the relationship of the RTP to the best bid price and the best ask price of the current data point before proceeding to the updating operation 1090.

In the updating operation 1090 of the algorithm 970, the following values are updated: bid trade volume and the ask trade volume of the current data point a bid large trade volume accumulator and an ask large trade volume accumulator, and the bid tick volume and the ask tick volume for the current data point. Each of the foregoing values is updated by adding in the trade volume from the RTPV the value according the previously determined proportions (i.e., the proportions attributed in steps 1076, 1080, and 1084).

Then the algorithm 970 branches to the query operation 1092 to determine whether either the bid large trade volume accumulator or the ask large trade volume accumulator exceeds the large volume threshold (e.g., a threshold set by threshold specification element 404, FIG. 4). As discussed above, during a sweep, the trade volume attributed to the sweeping order is accumulated. The bid large trade volume accumulator and the ask large trade volume accumulator are updated from successive RTPV trade volumes that are due to trades without any intervening bid RTPV or ask RTPV. When an intervening bid or ask order is received the sweep is considered to be completed. To account for the end of a sweep situation, when a bid RTPV is received the bid large trade volume accumulator is reset to 0. Similarly, when an ask RTPV is received, the ask large trade volume accumulator is reset to 0.

If the result of the query operation 1092 is “No”, the algorithm 970 branches directly to the updating operation 1096. If the result of the query operation 1092 in “Yes”, the algorithm branches to the updating operation 1094.

In the updating operation 1094 of the algorithm 970, the bid large trade volume value and/or the ask large trade volume value are updated. If the proportion of the trade volume previously allocated to the bid is greater than 0 and the bid large trade volume accumulator exceeds the large trade volume threshold, the bid large trade volume is updated by adding the bid large trade volume accumulator into the bid large volume, and then setting the bid large trade volume accumulator to 0. Similarly, if the proportion of the trade volume previously allocation to the ask is greater than 0 and the ask large trade volume accumulator exceeds the large trade volume threshold, the ask large trade volume is updated by adding the ask large trade volume accumulator into the ask large volume, and then setting the ask large trade volume accumulator to 0. The algorithm 870 then proceeds to the updating operation 1096.

In the updating operation 996 of the algorithm 970, if the open price of the current data point has not yet been set (e.g., the open price is INVALID or some other default value), the open price is set to the RTP. If the RTP is greater than the high price of the current data point, the high price is set to the RTP. If the RTP is less than the low price of the current data point, the low price is set equal to the RTP. Then the close price of the current data point is set equal to the RTP. Then the algorithm branches to the return operation 1002 to return to the calling process.

In an alternative embodiment, volume traded at the best bid price may be further categorized as “up bid trade volume” or “down bid trade volume” depending on the direction of the movement of the inside market. Similarly, volume traded at the best ask price may be further categorized as “up ask trade volume” or “down ask trade volume” depending on the direction of the movement of the inside market.

In accordance with one embodiment of the present invention, new price and corresponding bid trade volume and ask trade volume data points are generated and rendered on a bid/ask range bar chart according to the rendering rules described herein.

In one embodiment, a bid/ask range bar chart may be appended to a financial instrument trading interface, such as a dynamic price scale trading interface. The bid/ask range bar chart may provide to a trader various visual indications of buying or selling pressure in the market place, permitting the trader to make potentially more profitable trading decisions.

According to one embodiment, an end user, such as a trader, may be able to set volume thresholds that are used to determine the intensity of the color and/or the width of the bid/ask range bars. The volume thresholds may be expressed as absolute values, as a percent rank relative to historical volume values, or as percentages of a base volume where the base volume may be expressed as an absolute value or be algorithmically determined, for example, by calculating a median or a moving average of the historical volume values. Other algorithms may be used to determine the base volume. Because the volume thresholds can be quite different for different trading sessions, data may be segregated by session when using the historical data to determine the relative rank or the base volume threshold. The user may also explicitly set the colors that are used to shade the bars at the various traded volume thresholds.

In one embodiment, the bid/ask range data point's open price, high price, low price, close price, mid price, bid trade volume, or ask trade volume, may be used with additional analyses, such as a moving average or rate-of-change. As other examples, the result(s) of an analysis may be displayed in various manners, such as, but not limited to, an overlay on a bid/ask range chart, or in a separate window pane concurrently with, or independent of, other analytical displays and/or a trading interface. As yet another example, the result(s) of an analysis may also be used to create conditions that trigger the placement of orders to buy or sell a particular financial instrument.

In one embodiment, a bid/ask volume histogram chart including bars that illustrate the distribution of the volume traded at the best bid price and volume traded at the best ask price corresponding to a bar on a bid/ask range chart may be displayed concurrently with or independent of a bid/ask range chart and/or a trading interface. The volume bars may be displayed with the bid trade volume as a negative histogram bar colored red and the ask trade volume as a positive histogram bar colored green. Alternatively, the bid trade volume and the ask trade volume may be displayed as overlain positive histogram bars of different colors and/or widths.

In the alternative embodiment where the bid trade volume and the ask trade volume are further categorized as having resulted from large trades the end user may specify the volume threshold that determines the boundary between that identifies a large trades. The volume threshold may be expressed as an absolute value, as a percent rank relative to historical volume values, or as a percentage of a base volume where the base volume may be expressed as an absolute value or be algorithmically determined, for example, by calculating a median or a moving average of the historical volume values. Other algorithms may be used to determine the base volume. Because the volume thresholds can be quite different for different trading sessions, data may be segregated by session when using the historical data to determine the relative rank or the base volume threshold.

The volume bars may then be displayed with the bid trade volume as a negative histogram bar with two colors, for example, bright red for the portion of the bid trade volume resulting from large trades and dark red for the remaining portion of the bid trade volume and the ask trade volume as a positive histogram bar with two colors, for example, bright green for the portion of the ask trade volume resulting from large trades and dark green for the remaining portion of the ask trade volume. Alternatively, the bid trade volume and the ask trade volume may be displayed as overlain positive histogram bars of different colors and widths.

In one embodiment, a bid/ask on-balance volume line chart including a display of a line graph of the positive aggregation of the volume traded as the ask price corresponding to a bar on a bid/ask range chart and negative aggregation of the volume traded at the bid price corresponding to a bar on a bid/ask range chart may be displayed concurrently with or independent of a bid/ask range chart and/or a bid/ask volume chart and/or a trading interface.

In an alternative embodiment, a bid/ask on-balance volume line chart including the display of a line graph of the positive aggregation of the “up bid trade volume” and the weighted “up ask trade volume” when the inside market moves up and negative aggregation of the “down ask trade volume” and the weighted “down bid trade volume” when the market moves down may be displayed concurrently with or independent of a bid/ask range chart and/or a bid/ask volume chart and/or a trading interface.

In one embodiment, the on-balance volume values may be used with additional analyses, such as a moving average or rate-of-change. As other examples, the result(s) of an analysis may be displayed in various manners, such as, but not limited to, an overlay on a bid/ask range chart, or in a separate window pane concurrently with, or independent of, other analytical displays and/or a trading interface. As yet another example, the result(s) of an analysis may also be used to create conditions that trigger the placement of orders to buy or sell a particular financial instrument.

According to one embodiment, a bid/ask on-balance volume oscillator line chart including a display of a line graph of the difference between one moving average calculated using on-balance volume values and one set of parameters and another moving average calculated using on-balance volume values and a different set of parameters may be displayed concurrently with or independent of a bid/ask range chart and/or a bid/ask volume chart and/or any other analytical displays and/or a trading interface. In contrast to the bid/ask on-balance volume, the on-balance volume oscillator has values that are independent of the historical start time of the on-balance volume calculation.

In one embodiment, the on-balance volume oscillator values may be used with additional analyses, such as a moving average or rate-of-change. As other examples, the result(s) of an analysis may be displayed in various manners, such as, but not limited to, an overlay on a bid/ask range chart, or in a separate window pane concurrently with, or independent of, other analytical displays and/or a trading interface. As yet another example, the result(s) of an analysis may also be used to create conditions that trigger the placement of orders to buy or sell a particular financial instrument.

In one embodiment, the on-balance volume oscillator values may be used with additional analyses, such as a moving average or rate-of-change. The result of an analysis may be displayed either as an overlay on a bid/ask range chart or in a separate window pane concurrently with or independent of other analytical displays and/or a trading interface. The result of an analysis may also be used to create conditions that trigger the placement of orders to buy or sell a particular financial instrument.

Display or suppression of any of the described graphical user interface screens may be configurable by the end user and/or responsive to end user request.

Exemplary Computing Device

Embodiments of the present invention include various steps, which are described herein and the associated appendix. The steps may be performed by hardware components or may be embodied in machine-executable instructions, which may be used to cause a general-purpose or special-purpose processor programmed with the instructions to perform the steps. Alternatively, the steps may be performed by a combination of hardware, software firmware or human representatives of the parties or entities involved in the transaction.

Embodiments of the present invention may be provided at least in part as a computer program product, which may include a machine-readable medium having stored thereon instructions, which may be used to program a computer (or other electronic devices) to perform a process. The machine-readable medium may include, but is not limited to, floppy diskettes, optical disks, compact disc read-only memories (CD-ROMs), and magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments of the present invention may also be downloaded as a computer program product, wherein the program may be transferred from a remote computer to a requesting computer by way of data signals embodied in a carrier wave or other propagation medium via a communication link (e.g., a modem or network connection).

FIG. 11 is a schematic diagram of a computing device 1100 upon which a server or client side financial trading and/or analysis application may execute. According to the present example, the computing device 1100 includes a bus 1101, at least one processor 1102, at least one communication port 1103, a main memory 1104, a removable storage media 1105 a read only memory 1106, and a mass storage 1107. Processor(s) 1102 can be any know processor, such as, but not limited to, an Intel® Itanium® or Itanium 2® processor(s), or AMD® Opteron® or Athlon MP® processor(s), or Motorola® lines of processors. Communication port(s) 1003 can be any of an RS-232 port for use with a modem based dialup connection, a 10/100 Ethernet port, or a Gigabit port using copper or fiber. Communication port(s) 1103 may be chosen depending on a network such a Local Area Network (LAN), Wide Area Network (WAN), or any network to which the computing device 1100 connects. The computing device 1100 may be in communication with peripheral devices (not shown) such as, but not limited to, printers, speakers, cameras, microphones, or scanners.

Main memory 1104 can be Random Access Memory (RAM), or any other dynamic storage device(s) commonly known in the art. Read only memory 1106 can be any static storage device(s) such as Programmable Read Only Memory (PROM) chips for storing static information such as instructions for processor 1102. Mass storage 1107 can be used to store information and instructions. For example, hard disks such as the Adaptec® family of SCSI drives, an optical disc, an array of disks such as RAID, such as the Adaptec family of RAID drives, or any other mass storage devices may be used.

Bus 1101 communicatively couples processor(s) 1102 with the other memory, storage and communication blocks. Bus 1101 can be a PCI/PCI-X or SCSI based system bus depending on the storage devices used. Removable storage media 1105 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM).

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

While, for convenience, embodiments of the present invention are described herein with reference to specific data processing algorithms, bid/ask range charts, bid/ask volume charts and specific user interface screens for trading financial instruments in the form of dynamic price scales, the techniques described are equally applicable to various other types and structures of charts and trading paradigms.

Terminology

Brief definitions of terms used throughout this application and attached appendix are given below.

The term “financial instrument” generally refers to tradable entities such as but not limited to securities, commodity, currency, or index futures, options, and treasuries that are either bought or sold by specifying a price and a quantity.

The phrase “price bar” for a particular financial instrument generally refers to the graphical representation of a data entity that includes of four price values: an open price, which is the first price registered; a high price, which is the highest price registered for the discrete duration of the bar; a low price, which is the lowest price registered for the discrete duration of the bar; and a close price, which is the last price registered for the discrete duration of the bar. Prices considered in constructing the data entity may include bids, ask, and trades or just trades exclusively.

The phrase “bid/ask range bar” for a particular financial instrument refers to the graphical representation of a data entity that includes trade volume information as well as an open price, a high price, a low price and a close price.

The phrase “ask trade volume” for a particular financial instrument generally refers to the number of contracts or shares traded or, in an alternative embodiments the number of trades, that occurred at the ask price for the financial instrument within the particular financial instrument price range.

The phrase “bid trade volume” for a particular financial instrument generally refers to the number of contracts or shares traded or, in an alternative embodiment, the number of trades that occurred at the bid price for the financial instrument within the particular financial instrument price range.

The phrases “bid/ask range” or “inside market” for a particular financial instrument refers to the price region bounded by the currently established best or highest bid price and the currently established best or lowest ask price.

The phrase “pre-open period” refers to the period prior to the opening of a financial market for trading during which the financial exchange accepts limit orders and publishes the order book.

The phrase “the market is crossed” refers to a market state where the best bid is greater than or equal to the best ask.

The phrase “bar chart” refers to a graph with one or more window panes that share a common horizontal time scale. Each window pane may display one or more data points for each time point and may have one or more independent value scales.

The phrases “chart overlay” or “overlay” refers to the graphical display of one data set in the same window pane as another data set or other data sets.

The terms “connected” or “coupled” and related terms are used in an operational sense and are not necessarily limited to a direct connection or coupling.

The term “financial instrument” generally refers to anything that can be traded with quantities and/or prices. Examples of financial instruments include, but are not limited to, stocks, bonds, mutual funds, Exchange-Traded Funds (EFTs), stock futures, commodity futures, stock options, commodity options and the like.

The phrases “in one embodiment” “according to one embodiment,” and the like generally mean the particular feature, structure, or characteristic following the phrase is included in at least one embodiment of the present invention, and may be included in more than one embodiment of the present invention. Importantly, such phases do not necessarily refer to the same embodiment.

If the specification or Appendix states a component or feature “may”, “can”, “could”, or “might” be included or have a characteristic, that particular component or feature is not required to be included or have the characteristic.

The term “responsive” includes completely or partially responsive.

The term “trader” generally refers to anyone using an input device, computerized or otherwise, to place trade orders, either to buy or to sell a specific quantity of a financial instrument, into a market place.

We claim:

1. A computer-implemented method for analyzing financial data related to a financial instrument traded on an electronic exchange, wherein an inside market exists for the financial instrument, the method comprising:
over a current discrete time period of trading, serially receiving a plurality of sets of price and volume data, wherein each set of price and volume data includes a price corresponding to a best bid, a best ask, or a trade, and a volume representing the volume of units of the financial instrument available at the best bid price or best ask price or executed at the trade price;
generating a data point corresponding to the current discrete time period of trading, wherein the data point includes a start time of the discrete time period, a best bid price, a best ask price, a high price, a low price, a bid trade volume, a bid large trade volume, an ask trade volume, and an ask large trade volume of the financial instrument in the discrete time period;
determining whether the inside market has moved based at least in part on a relationship between the most recently received price and one or more of the current best bid price, the current best ask price, the current high price, and the current low price in the discrete time period;
if the inside market has not moved, updating the price and volume values of the current data point using the most recently received price and volume set;
if the inside market has moved, storing the current data point, initializing a new data point, updating the new data point using the most recently received price and volume set; and
repeating the receiving, determining, updating, and storing for the new data point during another discrete time period.

2. The method of claim 1 wherein determining whether the inside market has moved comprises:
for each set of received price and volume data that corresponds to a best bid or a best ask, setting the best bid price for the current discrete time period equal to the received bid price or setting the current best ask price for the current discrete time period to the received ask price and then determining if the current best ask price is less than or equal to the current best bid price, and
if the current best bid price is less than or equal to the current high price, indicating that the inside market has not moved.

3. The method of claim 2, wherein determining whether the inside market has moved further comprises:
if the current best ask price is greater or equal to the current best bid price, determining whether the current best bid price is greater than or equal to the current high price in the discrete time period; and
if the current best bid price is greater than or equal to the current high price, indicating that the inside market has moved.

4. The method of claim 3, wherein determining whether the inside market has moved further comprises:
if the current best bid price is less than the current high price, determining whether the current best bid price is greater than the current low price in the discrete time period; and
if the current best bid price is less than or equal to the current low price indicating that the inside market has not moved.

5. The method of claim 4, wherein determining whether the inside market has moved further comprises:
if the current best bid price is greater than the current low price determining whether a current best bid price in the discrete time period has been traded; and
if the current low price in the discrete time period has been traded, indicating that the inside market has moved.

6. The method of claim 5, wherein determining whether the inside market has moved further comprises:
if the current best bid price has not been traded, determining whether the current best ask price is less than or equal to a current tow price in the discrete time period; and
if the current best ask price is less than or equal to the current low price, indicating that the inside market has moved.

7. The method of claim 6, wherein determining whether the inside market has moved further comprises:
if the current best ask price is greater than the current tow price, determining whether a current best ask price is greater than or equal to the current high price; and
if the current best ask price is greater than or equal to the current high price, indicating that the inside market has not moved.

8. The method of claim 7, wherein determining whether the inside market has moved further comprises:
if the current best ask price is less than the current high price, determining whether a current high price in the discrete time period has been traded, and
if the current high price in the discrete time period has been traded, indicating that the inside market has moved.

9. The method of claim 1 wherein determining whether the inside market has moved further comprises indicating that the inside market has not moved if the current high price in the discrete time period has not been traded.

10. The method of claim 1, wherein determining whether the inside market has moved comprises:
for each set of received set of price and volume data that corresponds to an executed trade, determining whether the price of the trade is greater than a current high price during the discrete time period or less than a current low price in the discrete time period, and
if the price of the trade is greater than the current high price or less than the current low price, then indicating that the inside market has moved.

11. The method as recited in claim 1, further comprising, if the current best bid price in the discrete time period is greater than or equal to the current best ask price in the discrete time period, attributing half the volume of a trade to the bid trade volume and half the volume of the trade to the ask trade volume.

12. The method of claim 11 further comprising attributing all of the volume of a trade to the bid trade volume if the current best ask price in the discrete time period is greater than or equal to the current best bid price in the discrete time period and if the price of the received trade is less than or equal to a current best bid price in the discrete time period.

13. The method of claim 12 further comprising attributing all of the volume of a trade to the ask trade volume if the current best ask price in the discrete time period is greater than or equal to the current best bid price in the discrete time period and if the price of the trade is greater than or equal to a current best ask price during the discrete time period.

14. The method of claim 13 further comprising proportionately attributing volume of a trade to the bid trade volume and the ask trade volume based on the linearly interpolated difference of trade price relative to the current best bid price and the current best ask price if the current best ask price in the discrete time period is greater than or equal to the current best bid price in the discrete time period and if the price of the trade is greater than a current best bid price of the discrete time period and less than a current best ask price of the discrete time period.

15. The method of claim 14, further comprising:
attributing a portion of the bid trade volume to large trades executed during the discrete time period and a portion of the ask trade volume to large trades executed during the discrete time period;
wherein a large trade is a single trade of a financial instrument with a trade volume greater than a large volume threshold or a sequence of trades of a financial instrument, uninterrupted by the receipt of a new best bid or new best ask or by a change in the inside market, with a cumulative trade volume greater than a large volume threshold.

16. The method as recited in claim 15, wherein the large volume threshold is user-selectable.

17. The method of claim 1, further comprising:
displaying a price bar chart wherein each bar represents the data point for a discrete time period with a high price set to either the highest best ask price of the discrete time period that was traded or, if no trades occurred at the ask price, the lowest ask price that occurred over the duration of the discrete time period, a tow price set to either the lowest best bid price of the discrete time period that was traded or, if no trades occurred at the bid price, the highest best bid price that occurred over the duration of the discrete time period, a bid trade volume set to the proportion of the total trade volume allocated to the best bid price during the discrete time period and an ask trade volume set to the proportion of the total trade volume allocated to the best ask price during the discrete time period.

18. The method of claim 17 further comprising:
determining a total trade volume for a pre-determined number of prior discrete time periods,
computing a percent rank based on a comparison of the total volume in the current discrete time period to the distribution of the total trade volume in the pre-determined number of prior discrete time periods;
selecting a bar width, a bid color shade, and an ask color shade based on the percent rank;
displaying the bar with the selected width, with the bid portion in the bid color shade, and with the ask portion in the ask color shade.

19. The method of claim 18, further comprising setting a plurality of percentage thresholds, wherein at each threshold a different color shade is associated with ask trade percentages above the threshold, and a different color shade is associated with bid trade percentages above the threshold.

20. The method as recited in claim 19, wherein setting comprises setting four percentage thresholds corresponding to an extra large volume level, a large volume level, a medium volume level and a small volume level.

21. The method of claim 20, further comprising:
displaying the bid and/or the ask portion in a color shade associated with the extra large volume level when the bid or the ask percent rank is above the percentage threshold associated with the extra large volume level;
displaying the bid and/or the ask portion in a color shade associated with the large volume level when the bid or the ask percent rank is above the percentage threshold associated with the large volume level and below the percentage threshold associated with the extra large volume level;
displaying the bid and/or the ask portion in a color shade associated with the medium volume level when the bid or the ask percent rank is above the percentage threshold associated with the medium volume level and below the percentage threshold associated with the large volume level; and
displaying the bid and/or the ask portion in a color shade associated with the small volume level when the bid or the ask percent rank is above the percentage threshold associated with the small volume level and below the percentage threshold associated with the medium volume level.

22. The method as recited in claim 19, wherein both the bid trade volume and the ask trade volume correspond to zero volume, and a particular color shade is associated with zero volume.

23. The method of claim 1, further comprising:
displaying a volume histogram chart wherein each histogram bar represents the data point for a discrete time period of trading with a bid trade volume set to the proportion of the total trade volume allocated to the best bid price during the discrete time period and an ask trade volume set to the proportion of the total trade volume allocated to the best ask price during the discrete time period.

24. The method of claim 23 further comprising the display of a volume histogram chart representation of the data points wherein the graphical representation includes a bid trade volume portion displayed with a first aspect and an ask trade volume portion displayed with a second aspect.

25. The method of claim 24 wherein the displaying step comprises displaying the bid trade volume portion in a first color and displaying the ask trade volume portion in a second color.

26. The method as recited in claim 25, wherein the first color and the second color are user-selectable.

27. The method of claim 1, further comprising:
displaying a volume histogram chart wherein each histogram bar represents the data point for a discrete time period of trading with a bid trade volume set to the proportion of the total trade volume allocated to the best bid price during the discrete time period, a bid large trade volume set to the proportion of the bid trade volume attributed to large trades, an ask trade volume set to the proportion of the total trade volume allocated to the best ask price, and an ask large trade volume set to the proportion of the ask trade volume attributed to large trades during the discrete time period.

28. The method of claim 27 further comprising the display of a volume histogram chart representation of the data point, wherein the graphical representation includes a bid trade volume portion displayed with a first aspect, a bid large trade volume portion displayed with a second aspect, an ask trade volume portion displayed with a third aspect, and an ask large trade volume portion displayed with a fourth aspect.

29. The method of claim 28 wherein the displaying step comprises displaying the bid trade volume portion in a first color, the bid large trade volume portion in a second color, displaying the ask trade volume portion in a third color, and displaying the ask large trade volume portion in a fourth color.

30. The method as recited in claim 29 wherein the four colors are individually user-selectable.

31. The method as recited in claim 1, wherein the generating and displaying steps are performed using real-time financial data from the electronic exchange.

32. The method as recited in claim 1 wherein the generating and displaying steps are performed using historical financial data from the electronic exchange.

33. A computer-readable medium having computer-executable instructions, which, when executed by a computer, cause the computer to carry out a process for analyzing market data associated with a financial instrument traded on an electronic exchange, the process comprising:
sequentially calculating a plurality of data points wherein each data point is calculated over an associated discrete time period of trading, and wherein each data point comprises a high price, a low price, a best bid price, a best ask price, a bid trade volume, a bid large trade volume, an ask trade volume and an ask large trade volume for the discrete time period, and wherein calculating each data point comprises updating the high price, the low price, the best bid price, the best ask price, the bid trade volume, the bid large trade volume, the ask trade volume and the ask large trade volume based on a plurality of market data points received during the discrete time periods wherein each market data point comprises a price and a volume and a type indicator indicating whether the price and volume correspond to an ask order, a bid order, or an executed trade; and
during each discrete time period, determining whether to begin calculating another data point over a next discrete time period by comparing the price of a most recently received market data point to one or more of the best bid price, the best ask price, the current high price, and the current low price most recently updated during the discrete time period.

34. The computer-readable medium as recited in claim 33, wherein calculating a data point further comprises:
allocating volume of each market data point to one or both of bids and asks placed during the associated discrete time period, and wherein allocating comprises dynamically updating a bid trade volume and an ask trade volume during the associated discrete time period.

35. The computer-readable medium as recited in claim 34, wherein the process further comprises:
during each discrete time period displaying a bar representing the data point being calculated, wherein the bar includes a bid trade volume portion corresponding to the determined bid trade volumes and an ask trade volume portion corresponding to the determined ask trade volume.
dynamically updating the bid portion and the ask portion of the bar as the bid trade volume and the ask trade volume are dynamically updated.

36. The computer-readable medium as recited in claim 35, wherein allocating volume of each market data point comprises comparing the price of the market data point to one or more of the best bid price and the best ask price most recently updated during the discrete time period.

37. The computer-readable medium as recited in claim 36, wherein allocating volume of each market data point comprises linearly interpolating the price of the market data point between the most recent best bid price and the most recent best ask price during the discrete time period.
